(19) United States
(12) Patent Application Publication
(10) Pub. No.: US 2022/0025733 A1
(43) Pub. Date: Jan. 27, 2022

(54) Choke stem with replaceable stem tip

(71) Applicant: Nicholas Blane Babler, Greeley, CO (US)

(72) Inventor: Nicholas Blane Babler, Greeley, CO (US)

(21) Appl. No.: 17/300,522

(22) Filed: Aug. 2, 2021

Related U.S. Application Data
(63) Continuation of application No. 63/057,058, filed on Jul. 27, 2020.

(51) Int. Cl. E21B 34/02; E21B 43/26

(52) U.S. Cl. CPC E21B 34/025; E21B 43/26

(57) ABSTRACT

Adjustable chokes used during the hydraulic fracturing process are exposed to excessive wear and tear due to high pressures, sand, and various proppants extracted along with the fluids. Often it is simply the tip of the stem which has eroded while the rest of the stem body remains in relatively good condition. The present application discloses a novel system allowing for quick replacement of the stem tip and an efficient method for doing so.

### TECHNICAL FIELD

The present technology provides a system for replacing the tip of a choke stem, such as those used for flow control in the gas, oil, and mining industries, and a method to utilize the system.

### BACKGROUND OF THE DISCLOSURE

Adjustable chokes are commonly used for controlling the flow rate of fluids passing through a pipeline, well, or process facility. The flow rate is controlled by a variable mechanical restriction formed between the choke body and the tip of the choke stem. Adjustable chokes, which are used during the hydraulic fracturing process, are exposed to additional wear and tear due to high pressures, sand, and various proppants extracted along with the fluids. In this harsh environment, stems may need to be replaced multiple times during a shift, thereby causing delays in production and material expense incurred in changing the choke stem. Often it is simply the tip of the stem which has eroded while the rest of the stem body remains in relatively good condition.

The present application discloses a novel system allowing for quick replacement of the stem tip and an efficient method for doing so.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure but are intended to be illustrative only.

FIG. 1 shows the choke stem assembly including the body and the replaceable tip, in accordance with an embodiment of the present disclosure.

FIG. 2 shows an exploded view of the primary components that make up the choke stem assembly including the stem body and replaceable stem tip, in accordance with an embodiment of the present disclosure.

FIG. 3 shows the components that make up the replaceable stem tip of the choke stem, in accordance with an embodiment of the present disclosure.

FIG. 4 shows a proximal view of the carbide tip, in accordance with an embodiment of the present disclosure.

FIG. 5 shows the attachment point of the stem body and the replaceable stem tip, in accordance with an embodiment of the present disclosure.

FIG. 6 shows a cut away view of the choke stem assembly, in accordance with an embodiment of the present disclosure.

FIG. 7 shows the alignment and locking fastener of the choke stem assembly, in accordance with an embodiment of the present disclosure.

FIG. 8 shows the alignment and locking fastener of the choke stem fully secured, in accordance with an embodiment of the present disclosure.

FIG. 9 shows a valve manifold utilizing the choke stem with a replaceable stem tip, in accordance with an embodiment of the present disclosure.

FIG. 10 illustrates the method for removal of the upper choke valve assembly with the choke stem, in accordance with an embodiment of the present disclosure.

FIG. 11 illustrates the method for removal and replacement of the stem tip while the stem body remains within the upper choke valve assembly, in accordance with an embodiment of the present disclosure.

### DETAILED DESCRIPTION OF EMBODIMENTS

The stem tip used by choke valves to control the high-pressure flow of fluids and accompanying proppants can wear quickly during the hydraulic fracturing or fracking process. To accommodate maintenance of the choke valve, stems are routinely changed.

The process to change the stem is time consuming and includes removing the locking nut from the lower manifold body, removing packing, gaskets, and the handle. Often the only wear point, which necessitated the changeover, is the tip of the stem in the area that it restricts the opening between the stem tip and the seat of the valve manifold.

Herein, a stem with a replaceable stem tip is described to reduce changeover time and reduce costs by changing only the part of the stem assembly that is worn. This specification provides illustrations and examples to present higher level concepts which will be apparent to the reader.

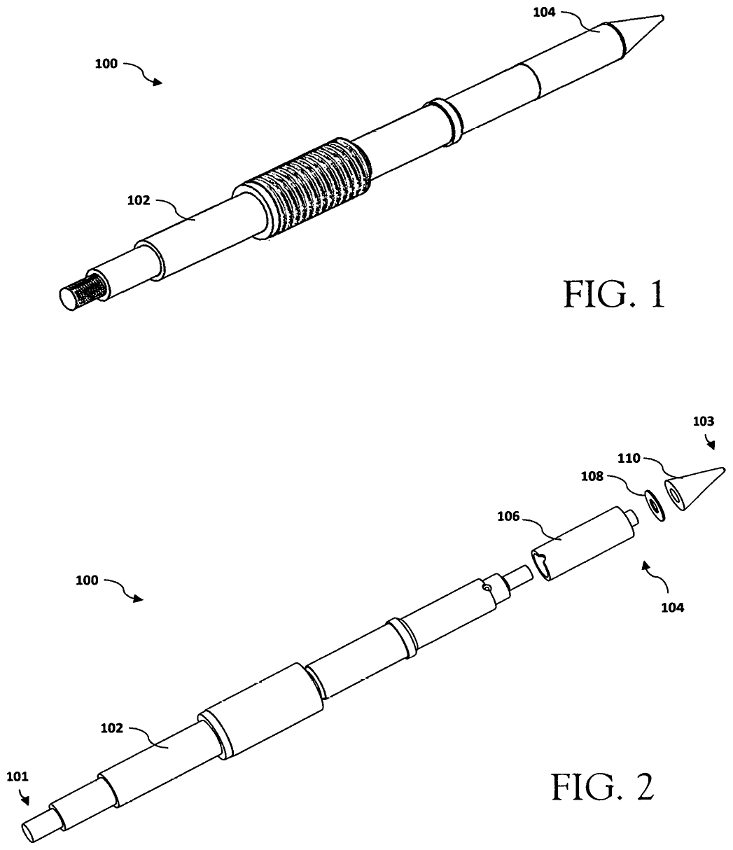

FIG. 1 shows the full stem assembly 100 comprising of the stem body 102 and the stem tip assembly 104. FIG. 2 shows the full stem assembly 100 with a further breakdown of the components comprising the stem tip assembly 104. The stem tip assembly 104 includes the stem tip body 106 and a carbide tip 110. Also shown is a brazing ring 108 used during assembly.

In terms of relative positioning and assembly, the stem assembly 100 has a proximal end 101 and a distal end 103. All components shown in FIG. 2 are axially located along a central axis extending from the proximal 101 to distal 103 end.

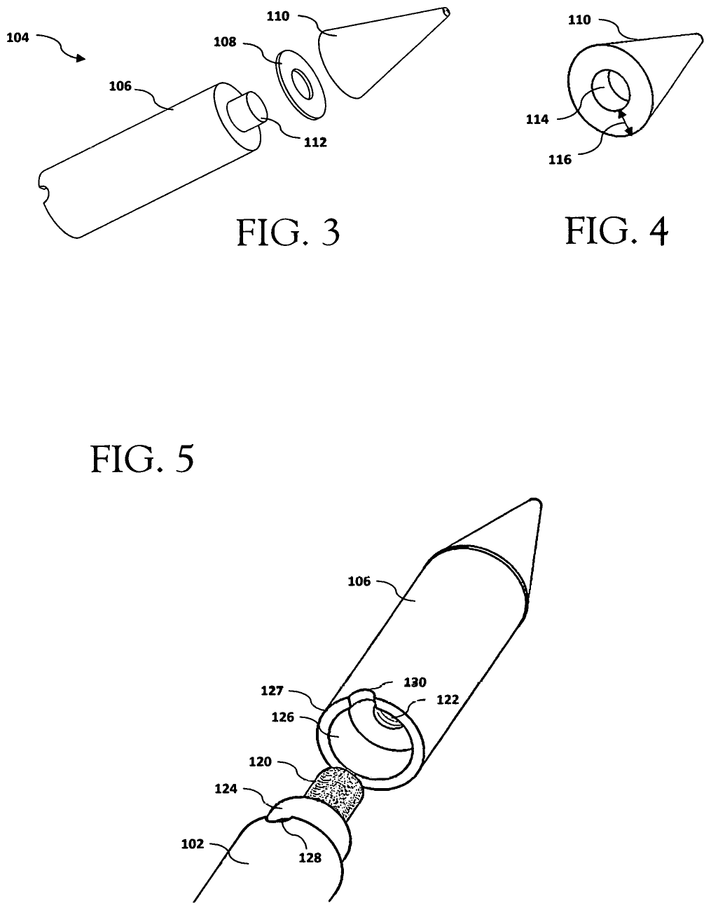

FIG. 3 shows the components which make up the stem tip assembly 104. In the preferred embodiment, the tip body 106 may be constructed from a high-grade steel. In the preferred embodiment, the carbide tip 110 is constructed from a tungsten carbide. In an alternative embodiment, the carbide tip 110 may be created from a material formed or coated by synthetic or polycrystalline diamond. In the preferred embodiment, a brazing ring 108 having a thermal reaction to an induction heater is used to facilitate an induction brazing process.

As shown in FIG. 3 and FIG. 4, the tip body 106 and the carbide tip 110 have mating features illustrated by the tip body rod 112 and carbide receiver 114. These mating features aid in the manufacturing process for centering and add additional strength to the joint. During the manufacturing process, the tip body rod 112 passes through the annular of the brazen ring 108. Per the brazen process, flux is applied to all the contacting and mating surfaces of the tip body 106, brazen ring 108, and carbide tip 110. In the preferred embodiment the tip body rod 112 and carbide receiver 114 are circular in shape, but alternative embodiments may be square or keyed for specifying orientation.

FIG. 4 is a proximal view of the carbide tip 110 wherein the carbide tip has a radius 116. It should be understood that the concepts presented herein apply to carbide tips 110 of various radii—such as those used in the mining and oil industries. The radius of the carbide tip may be larger than the corresponding radius of the tip body 106.

FIG. 5 shows the mating connection between the tip body 106 and the stem body 102. In the preferred embodiment, the stem body 102 (having a first radius) has two concentric circular extensions, herein referred to as the stem rod 124 and the stem thread 120, creating a second and third radius. The first radius is larger than the second radius, and in the preferred embodiment, the second radius is larger than the third radius. In an alternative embodiment, the second radius is smaller than the third radius. In the preferred embodiment and as shown in FIG. 5, the distal extension of the stem thread 120 is exceeds the distal extension of the stem rod 124. In an alternative embodiment, the distal extension of the stem thread 120 proceeds the distal extension of the stem rod 124.

The tip body 106 has a proximal annular extension 127 with an inner surface referred to as the tip receiver 126. In the preferred embodiment, the outside diameter of the annular extension 127 is equivalent to the diameter of the stem body 102. In the preferred embodiment, the stem thread 120 has a ½-24 thread which mates with the threads of the tip thread 122, and the stem rod forms a line-to-line fit with the inner surface of the tip receiver 126 of the tip body 106.

Along the distal edge of the stem body 102 and prior to the extension of the stem rod 124 resides the stem alignment orifice 128 comprising a half circle opening distally. A corresponding proximally opening half circle, herein referred to as the tip alignment orifice 130, resides along and protrudes through a wall of the proximal annular extension 127.

To assemble the tip body 106 to the stem body 102, the tip body is rotated such that the tip thread 122 engages with the stem thread 120. The tip body 106 continues to be rotated until a mechanical limit is reached either by the limit of the threads or mechanical interference from another part of the stem body 102. Upon reaching the mechanical limit, the tip body is counter rotated, such that the stem and tip alignment orifice, 128 and 130, align. In the preferred embodiment, the stem and tip alignment orifice, 128 and 130, will align simultaneous to the rotational mechanical limit.

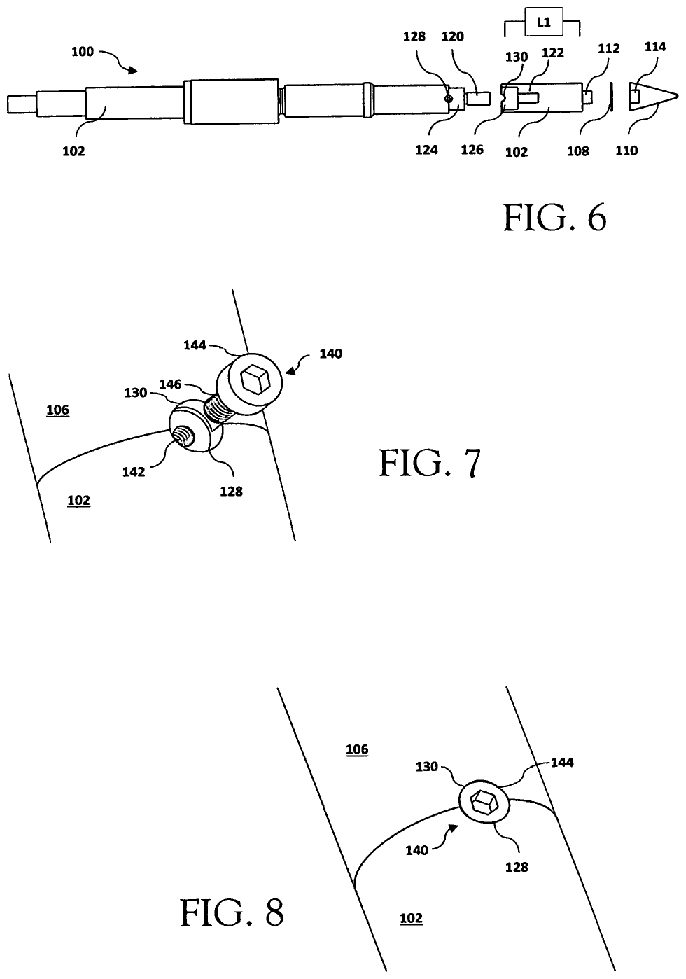

FIG. 6 is a downward cross section of the stem assembly 100. As described previously the stem rod 124 and stem thread 120 respectively mate or engage with the tip receiver 126 and tip thread 122, and rotate such that the stem and tip alignment orifice, 128 and 130, are aligned. The tip body rod 112 passes through the brazing ring 108 and occupies the void inside carbide receiver 114 such that the tip body 102, brazing ring 108, and proximal end of the carbide tip are in communication with each other.

Also shown in FIG. 6 is the tip body length L1. In the preferred embodiment, this length is at least 3 inches. This length is required to protect the stem and tip alignment orifices, 128 and 130, from being eroded by debris in the fluid.

FIG. 7 shows a fastener in the form of a bolt 140 being inset into countersunk hole defined by perimeter formed of the tip and stem alignment orifice, 130 and 128. The bolt 140 includes a bolt head 144 and a bolt thread 146. The bolt thread 146 engages with the bolt receiver threads 143.

FIG. 8 shows the bolt 140 fully engaged within the bolt receiver threads 143. The bolt head 144 forms a line-to-line fit with the perimeter of the stem alignment orifice and the tip alignment orifice, thereby restricting any rotational movement between the stem body 102 and the tip body 106.

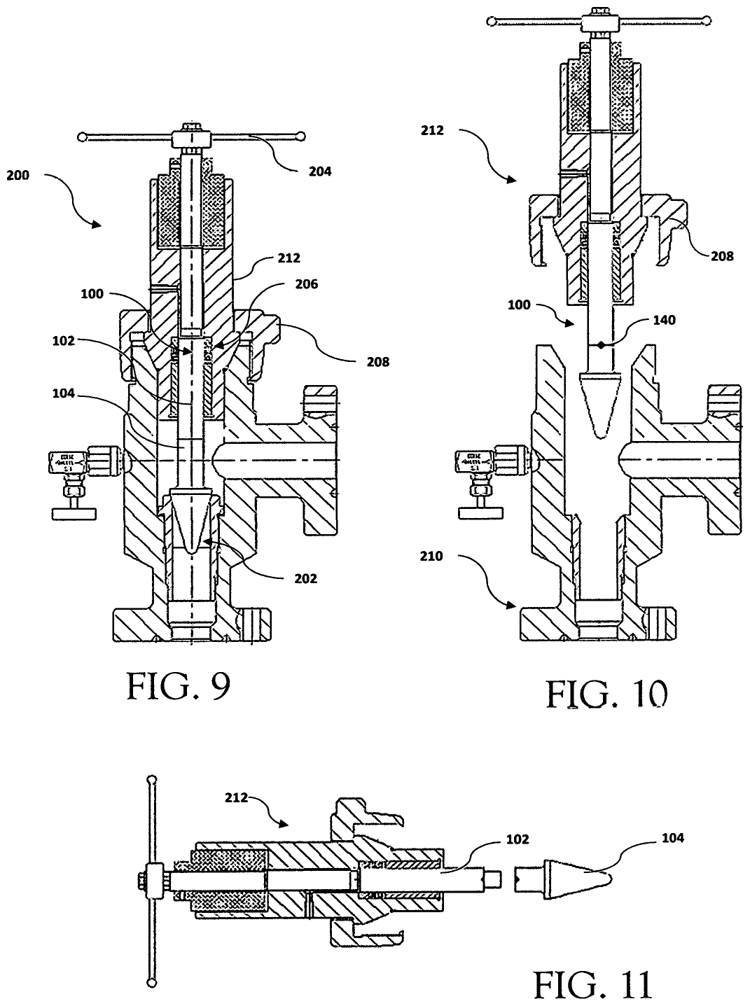

FIGS. 9, 10, and 11 illustrate the efficiency benefits during a change over utilizing the choke stem assembly 100 with replaceable stem tip. A cross section of an adjustable choke valve assembly 200 is shown in FIG. 9. The choke valve includes a stem assembly having a stem body 102 and stem tip assembly 104. A restriction area 202 which controls the flow resides below the stem tip assembly. A handle is coupled to the proximal end of the stem assembly 100. A locking nut 208 holds the upper and lower choke assembly together. The choke valve assembly 200 also includes an area for packing material 206 which is commonly used to form a seal between the stem body 102 and the upper choke assembly 212.

Significant deconstruction of the parts above are required in order to change out a conventional stem. This would include removal of the handle 204 from the stem body 102, release of the locking nut 208, removal of packing materials 206 and other components—all of which takes time.

The steps required for changeover of the stem assembly 100 with replaceable tip are presented in FIGS. 10 and 11. First, the locking nut 208 is released allowing the choke valve assembly 200 to become the upper choke assembly 212 with the stem assembly 100, and the lower choke assembly 210. The operator now has access and may undo the alignment bolt 140 from the bolt receiver 142. As shown in FIG. 11, with the bolt removed, the stem tip assembly 104 may be unscrewed and removed from the stem body 102.

With the stem body 102 still within the upper choke assembly 212, replacement with a new stem tip assembly 104 is simply done in reverse. The stem tip assembly 104 is aligned and screwed onto the stem body 102. The rotation is done until it reaches a mechanical stop and counter rotated such that the stem and tip alignment orifices, 128 and 130, align to form the counterbore for the bolt head 144. The bolt 140 is secured into place within the bolt receiver 142 such that the bolt head 144 is countersunk within the stem body 102.

Because the new carbide tip 110 may be larger than the previously worn tip, the handle 204 is rotated such that the stem assembly is backed away from the seat of the choke valve. The upper choke assembly 212 is placed on top of the lower choke assembly 210, and the upper and lower choke assemblies are secured by the locking nut 208.

After more testing on the replaceable stem. Current Changes that are being developed are
Stem thread is now on replaceable tip end this is also has a small groove to secure metal to metal connection
There is a small single sided hole that a small hex bolt goes thru to secure Stem Tip to Stem body.
With the changes that have been made to the tip and the body clocking each stem body isn't necessary to do with new design.

The new drawing is showing the new stem tip design, The stem tip changed now carrying the threaded end with a groove to secure the tip to the body. This will eliminate the need for mechanical clocking in the machine shop.

Now the Stem Tip has a hole passing thru the Stem tip to the Body of the choke stem that puts pressure on the body holding the steel-to-steel connection from spinning loosely.

What is claimed is:

1. A method to remove a replaceable tip of a stem assembly used in an adjustable choke valve comprising:
(a) removing the locking nut of the adjustable choke valve, thereby creating an upper choke valve assembly and a lower choke valve assembly,
i. wherein the upper choke valve assembly includes the stem assembly,
ii. wherein the stem assembly includes a stem body, a replaceable tip, and an alignment bolt securing a replaceable tip to the stem body;
(b) removing the alignment bolt from the stem assembly; and
(c) unscrewing the tip of the stem assembly from the stem body.
